(19) United States
(12) Patent Application Publication
(10) Pub. No.: US 2025/0122121 A1
(43) Pub. Date: Apr. 17, 2025

(54) USE OF A FRACTION OBTAINED FROM USED CONCRETE AS SAND FOR THE PREPARATION OF CONCRETE OR MORTAR

(71) Applicant: VICAT, L'Isle-d'Abeau (FR)

(72) Inventors: Yvan-Pierre JACOB, Pont de Beauvoisin (FR); Julien POILLOT, Lyon (FR); Hervé GUILLEMIN, Sermerieu (FR)

(73) Assignee: VICAT, L'Isle-d'Abeau (FR)

(21) Appl. No.: 18/293,511

(22) PCT Filed: Aug. 1, 2022
(86) PCT No.: PCT/FR2022/051533

§ 371 Date: Jan. 30, 2024

(30) Foreign Application Priority Data
Aug. 2, 2021 (FR) 21/08400

(51) Int. Cl. C04B 14/06

(52) U.S. Cl. CPC C04B 14/06

(57) ABSTRACT

A method for preparing concrete or mortar using a fraction whose particle size d₁₀ is greater than or equal to 150 μm, the fraction having a loss on ignition varying from 3% to 30% and including: from 20% to 80% SiO₂; from 5% to 40% CaO; from 1% to 15% Al₂O₃; and from 0.5% to 4% Fe₂O₃.

The present invention relates to the revaluation of concrete at the end of its life, and more particularly the use of a fraction obtained from used carbonated concrete as a substitute sand for the preparation of concrete or mortar.

The construction materials are materials used in the building and public works sectors. They cover a wide range of materials which mainly includes wood, glass, steel, aluminum, textiles, plastics (in particular insulating materials) and materials resulting from the transformation of quarry products, which can be more or less elaborate, notably concrete, mortars and various clay derivatives such as bricks, tiles, tiled floors and various sanitary elements.

For economic, ecological and climatic reasons, there has been a need for several years to save natural and energy resources, and to limit greenhouse gas emissions.

This is particularly true for construction materials prepared from hydraulic binders such as concrete and mortars, the preparation methods of which require a significant input of energy and natural raw materials, and emit large quantities of CO₂.

Indeed, the manufacture of hydraulic binders, and in particular that of cements, essentially consists of the calcination of a mixture of judiciously selected and measured raw materials, also called by the term «raw». Cooking this raw material produces an intermediate product, clinker, which, when ground with possible mineral additions, will produce cement. The type of manufactured cement depends on the nature and proportions of the raw materials as well as the cooking method.

There are several types of cements: Portland cements (which represent the vast majority of cements produced in the world), aluminous cements (or calcium aluminate), natural quick cements, sulpho-aluminous cements, sulfobelitic cements and other intermediate varieties.

The most widely used cements are Portland type cements. Portland cements are obtained from Portland clinker, obtained after clinkering at a temperature of about 1450° C. of a raw material rich in calcium carbonate in an oven. The production of a ton of Portland cement is accompanied by the emission of very large quantities of CO₂ (about 0.8 to 0.9 tons of CO₂ per ton of cement in the case of a CEM I).

However, in 2014, the quantity of cement sold worldwide was about 4.2 billion tones (source: Syndicat Français de l'Industrie Cementière—SFIC). This figure, constantly increasing, has more than doubled in 15 years. The cement industry is therefore today looking for a valid alternative to Portland cement, that is to say cements presenting at least the same resistance and quality characteristics as Portland cements, but which, during their production, release less CO₂.

During the production of clinker, the main constituent of Portland cement, the release of CO₂ is linked to:
up to 40% for heating the cement kiln, grinding and transport;
up to 60% to so-called chemical CO_{2,} or decarbonation.

Decarbonation is a chemical reaction that takes place when limestone, the main raw material for the manufacture of Portland cement, is heated at high temperatures. The limestone is then transformed into quicklime and CO₂ according to the following chemical reaction:

CaCO₃→CaO+CO₂

Natural carbonation of cement-based materials, particularly concretes, is a potential way to reduce the carbon footprint linked to the manufacturing process and the use of cement. However, although concrete prepared from these cements are naturally recarbonated during the life of the structures up to 15% to 20% of the CO₂ emitted during manufacturing, the carbon footprint associated with the production of Portland cement remains positive. It therefore remains necessary to reduce CO₂ emissions during the production of Portland cement and/or to improve end-of-life concrete recovery methods.

To reduce CO₂ emissions linked to the production of construction materials prepared from Portland cement, several approaches have been considered until now:
the adaptation or modernization of cement methods in order to maximize the efficiency of heat exchanges;
the development of new «low carbon» binders such as sulpho- aluminous cements prepared from raw materials less rich in limestone and at a lower cooking temperature, which allows a reduction in CO₂ emissions of about 35%;
or the (partial) substitution of clinker in cements with materials making it possible to limit CO₂ emissions.

Carbon capture and storage technologies have also been developed to limit CO₂ emissions from cement plants or coal-fired power plants. International patent application WO-A-2019/115722 describes a method for both the cleaning of CO₂-containing exhaust gases and the manufacture of additional cementitious material. The described method involves using recycled concrete fines comprising providing recycled concrete fines with d₉₀ ≤1000 μm into stocks or a silo as a feedstock, rinsing the feedstock to provide a carbonaceous material, the removal of the carbonaceous material and the cleaned exhaust gas, and the deagglomeration of the carbonaceous material to form the additional cementitious material, as well as the use of stocks or a silo containing a starting material of recycled concrete fines with d₉₀ ≤1000 μm for cleaning CO₂-containing exhaust gases and simultaneously manufacturing additional cementitious material. However, this method requires drying the carbonated product before it can be used.

At the date of the present invention, it remains necessary to identify new ways to significantly reduce CO₂ emissions during the production of construction materials, but also to improve the recycling methods of used concrete, which can have a significant impact on the carbon footprint associated with the production of construction materials.

In « Feasability and performance analysis of carbonated recycled aggregate concrete », International Journal of Sustainable Engineering, 2021, Vol. 14, No. 4, 761-775, authors Singh et al. are studying the improvement of the quality of recycled coarse concrete aggregates (gravel type) by rapid carbonation. Three mix combinations named NAC (using 100% natural coarse aggregates), RAC (using 100% recycled coarse aggregates) and CRAC (using 100% carbonated recycled coarse aggregates) are studied. The authors conclude that the use of carbonated recycled concrete aggregates improves the non-destructive, mechanical and durability properties of RAC. The studies carried out by the authors, however, only concern coarse aggregates and cover the entire fraction obtained after sieving the recycled concrete. The valorization of sand fractions is not mentioned.

However, it has now been found, quite surprisingly, that certain fractions resulting from the recycling of used concrete could be used as sand for the preparation of concrete or mortars, which makes it possible to recycle used concrete and preserve natural resources, for a little that the finest particles of said fraction are removed and that the fraction thus obtained is previously carbonated. The use of such fractions makes it possible to significantly reduce the general carbon footprint associated with the production of cement, concrete or mortar due to the capture of CO₂ emitted by the cement plant by the used concrete while maintaining short, medium and long-term mechanical properties of concrete or mortar finally prepared in accordance with expectations.

Thus, the subject of the present invention is the use of a fraction whose particle size d₁₀ is greater than or equal to 150 μm, said fraction having a loss on ignition varying from 3% to 30% and comprising:
from 20% to 80% SiO₂;
from 5% to 40% CaO;
from 1% to 15% Al₂O₃; and
from 0.5% to 4% Fe₂O₃;
   as sand for the preparation of concrete or mortar.

Against all expectations, the fractions defined previously, by carbonation of a fraction obtained from a construction material, in particular concrete, at the end of its life, in which the finest particles have been removed can be used as sand for the preparation of mortars or concretes, which makes it possible to recycle used concretes and preserve natural resources while maintaining mechanical strengths comparable to those of concretes or mortars prepared from conventional sands. Moreover, to the extent that, to be used as sand, the fraction obtained from used construction materials must first be carbonated, this makes it possible to significantly lower the general carbon footprint associated with the production of new construction materials such as concrete or mortar.

In the context of the present invention:
the term «sand» means any sand likely to be used by those skilled in the art for the preparation of construction material;
the term «loss on ignition» means the cumulative content of bound water, organic matter, CO₂ of carbonates (limestone fillers and carbonated part of the material) and possible oxidizable elements. The loss on ignition is determined by calcination in air at a temperature of (950+/−25° C.) according to the method described in standard NF EN 196-2 (classification index P 15-472)—Methods for testing cements—Part 2: Chemical analysis of cements; and
the term «construction material» means concrete or mortar.

In the context of the present invention, «d₁₀» corresponds to the diameter below which 10% of the total mass of the particles of the considered sample is located. This can be determined by any method known to those skilled in the art, in particular by dry or wet laser granulometry.

In the context of the present invention, «d₉₀» corresponds to the diameter below which 90% of the total mass of the particles of the considered sample is located. This can be determined by any method known to those skilled in the art, in particular by dry or wet laser granulometry.

In the context of the present invention, the diameter of the particles can be determined by any method known to those skilled in the art, in particular by scanning electron microscopy, morphogranulometry or by laser granulometry.

Finally, in the context of the present invention, the proportions expressed in % correspond to mass percentages relative to the total weight of the considered entity (e.g. clinker or cement).

The subject of the present invention is therefore the use of a fraction having the characteristics, in particular particle size and mineralogical characteristics, described previously as sand for the production of concrete or mortar. Preferably, the present invention relates to the use of a fraction as defined above as sand for the production of concrete or mortar, said fraction having the following characteristics, selected alone or in combination:
the particle size d₁₀ of the fraction is greater than or equal to 180 μm. More preferably, the particle size d₁₀ of the fraction is greater than or equal to 200 μm. Very preferably, the particle size d₁₀ of the fraction is greater than or equal to 250 μm;
the particle size d₉₀ of the fraction is less than or equal to 4000 μm. 30 More preferably, the particle size d₉₀ of the fraction is less than or equal to 3000 μm. Very preferably, the particle size d₉₀ of the fraction is less than 2000 μm;
the fraction has a loss on ignition varying from 4% to 25%, more preferably from 6% to 20%;
the fraction contains 30% to 70% SiO₂. More preferably, the fraction 35 contains from 40% to 60% SiO₂;
the fraction contains 10% to 30% CaO. More preferably, the fraction contains 10% to 20% CaO;
the fraction contains 2% to 10% Al₂O₃. More preferably, the fraction contains 4% to 8% Al₂O₃;
the fraction contains 1% to 3% Fe₂O₃. More preferably, the fraction contains from 1% to 2.5% of Fe₂O₃;
the fraction also contains from 0.1% to 3%, preferably from 0.5% to 2% of MgO;
the fraction also contains from 0.05% to 2%, preferably from 0.1% to 1% of TiO₂;
the fraction also contains from 0.1% to 3%, preferably from 0.5% to 2.5% of K₂O;
the fraction also contains from 0.05% to 2%, preferably from 0.1% to 1%, of Na₂O;
the fraction also contains from 0.01% to 1%, preferably from 0.05% to 0.5%, of P₂O₅;
the fraction also contains from 0.005% to 0.2%, preferably from 0.01% to 0.1%, of Mn₂O₃; and or the fraction also contains from 0.05% to 3%, preferably from 0.1% to 1.5%, of SO₃.

The fraction described above is therefore obtained by carbonation of a fraction obtained from a construction material, in particular concrete, at the end of its life. Thus, the present invention also relates to a method for preparing a fraction as described above, said method comprising the following steps:
metal removal and crushing of construction material;
screening of the crushed product in order to obtain a desired fraction at d₉₀;
drying of the fraction thus obtained;
separation using a dynamic separator to obtain the desired fraction at d₁₀; and
carbonation of the fraction obtained with a gas containing CO₂, such as cement plant gas.

The metal removal and the crushing of the construction material can be carried out according to any method known to those skilled in the art, in particular by shearing the concrete scrap then by magnetic metal removal by «overband» and finally crushing of the construction material by a crusher percussion, for example, which helps reduce the size of the aggregates.

The screening is a mechanical operation carried out using devices commonly called screens which allows selecting the grains. The screen only allows elements smaller than a certain size to pass through its mesh. They are equipped with perforated grids with openings of a determined size depending on the desired grain size. There are inclined vibrating screens and horizontal vibrating screens. The screening can be carried out using any method known to those skilled in the art. Preferably, the fraction obtained after screening is a fraction 0/4 mm, preferably 0/2 mm.

The fine fractions are obtained by using a dynamic separator which allows the separation of the particles it receives according to their size, shape and density. The product feeding the separator falls onto the rotating distribution hub. The centrifugal force projects the particles: the coarsest ones are projected towards the periphery, their speed decreases and, under the action of gravity, fall into the refusal cone from where they are evacuated to then be carbonated. Finer particles are carried by rising air to the separation zone where variable angle selector blades impart additional centrifugal force to remove remaining coarse particles. The rotation speed, ventilation and the angle of the turbine blades make it possible to adjust the desired particle size. If the ventilation of the separator is provided by hot air, it also has the ability to dry the materials.

The fraction described above can therefore be used as sand to prepare concrete or mortar without affecting the properties, particularly mechanical, of said concrete or mortar. The substitution rate of the natural sand used to prepare the concrete or mortar by the fraction described above can be up to 70%, more preferably up to 50%, most preferably up to 30%.

The present invention can be illustrated in a non-limiting manner by the following examples.

### EXAMPLE 1—FRACTIONS USED ACCORDING TO THE INVENTION

The different fractions were obtained in the laboratory after sieving with Alpine of different «concrete sands» with a particle size of 0/2 mm according to standard NF EN 933-10.

A sieve with a square mesh of variable size was used to remove the finest particles except for the F-0 fraction which corresponds to raw «concrete sand», that is to say without removing the finest particles.

The fractions retained by the sieve (i.e. refusal) are then subjected to carbonation by a mixture of bottled gases containing 25% CO₂ for 6 hours with stirring in a heating mixer (temperature set at 55° C.).

The mineralogical compositions and the particle size of the different fractions thus obtained are reported in the following Table 1.

TABLE 1
Mineralogical composition and particle size of fractions F-0 to F-3.

| | Fraction | Fraction | Fraction | Fraction |
|---|---|---|---|---|
| | F-0 | F-1 | F-2 | F-3 |
| SiO₂ (% w/w) | 48.12 | 52.23 | N.D. | 64.65 |
| CaO (% w/w) | 6.15 | 3.67 | N.D. | 6.38 |
| Al₂O₃ (% w/w) | 18.20 | 25.51 | N.D. | 14.06 |
| Fe₂O₃ (% w/w) | 0.60 | 0.57 | N.D. | 0.76 |
| MgO (% w/w) | 1.32 | 1.55 | N.D. | 1.36 |
| TiO₂ (% w/w) | 0.13 | 0.14 | N.D. | 0.19 |
| K₂O (% w/w) | 1.85 | 0.96 | N.D. | 2.34 |
| Na₂O (% w/w) | 0.38 | 0.26 | N.D. | 0.59 |
| P₂O₅ (% w/w) | 0.06 | 0.09 | N.D. | 0.12 |
| Mn₂O₃ (% w/w) | 0.04 | 0.04 | N.D. | 0.04 |
| SO₃ (% w/w) | 0.37 | 0.45 | N.D. | 0.51 |
| Loss of ignitition | 19.78 | 14.72 | N.D. | 8.33 |
| CO2 Gain (kg/t) | 20 | 31 | 23 | 16 |
| d₁₀ (μm) | 63 | 150 | 180 | 200 |
| d₉₀ (μm) | 1980 | 1900 | 1900 | 1900 |

### Example 2—Concretes/Mortars

Four concretes of the C25 XF1 type were prepared using a standard method:
the reference concrete 1 is prepared with the addition of sand and common natural aggregates;
the concrete 2 is prepared with the same elements as concrete 1 but by substituting 30% of the sand used by fraction F-0;
the concrete 3 is prepared with the same elements as concrete 1 but by substituting 30% of the sand used by fraction F-1; and
the concrete 4 is prepared with the same elements as concrete 1 but by substituting 30% of the sand used by fraction F-3.

### Example 3—Mechanical Performance

The compressive strength of concretes 1 to 3 was measured according to standard NF EN 12390-3 on specimens measuring 11×22 cm after 7 and 28 days of wet curing (20° C.).

The obtained results are presented in the following Table 2

TABLE 2
Mechanical resistance of concretes 1 to 4

| | Rc (in MPa) | Rc (in MPa) |
|---|---|---|
| | at 7 days | at 28 days |
| Concrete 1 | 29 | 36.5 |
| Concrete 2 | 26.1 | 31.4 |
| Concrete 3 | 28.8 | 37.3 |
| Concrete 4 | 29.1 | 36.4 |

The measured mechanical strengths are equivalent between the reference concrete without recycled sand (concrete 1) and the concretes prepared with fractions F-1 and F-2 (concretes 3 and 4). On the other hand, for the concrete prepared from fraction F-0 (concrete 2), the measured mechanical resistances are significantly lower than what can be expected.

Furthermore, compared to concrete 1, concretes 3 and 4 have a carbon footprint reduced by 8.5% and 10.8% respectively.

These results demonstrate that the removal of the finest particles from recycled concrete fractions allows, after carbonation of the obtained fraction, the use of these fractions as aggregate for the preparation of concretes presenting an acceptable level of performance while significantly reducing their carbon footprint.

1. A method comprising preparing a concrete or mortar using a fraction whose particle size d₁₀ is greater than or equal to 150 μm, the fraction having a loss on ignition varying from 3% to 30% and comprising:
from 20% to 80% SiO₂;
from 5% to 40% CaO;
from 1% to 15% Al₂O₃; and
from 0.5% to 4% of Fe₂O₃.

2. The method according to claim 1, wherein the particle size d₁₀ of the fraction is greater than or equal to 180 μm.

3. The method according to claim 2, wherein the particle size d₁₀ of the fraction is greater than or equal to 200 μm

4. The method according to claim 1, wherein the particle size d₉₀ of the fraction is less than or equal to 4000 μm.

5. The metho according to claim 4, wherein the particle size d₉₀ of the fraction is less than or equal to 3000 μm

6. The method according to claim 1, wherein the fraction has a loss on ignition varying from 4% to 25%.

7. The method according to claim 1, wherein the fraction contains from 30% to 70% SiO₂.

8. The method according to claim 1, wherein the fraction contains from 10% to 30% CaO.

9. The method according to claim 1, wherein the fraction contains from 2% to 10% Al₂0₃.

10. The method according to claim 1, wherein the fraction contains 1% to 3% Fe₂O₃.

11. The method according to claim 1, wherein the fraction contains from 0.1% to 3% MgO.

12. The method according to claim 1, wherein the fraction contains 0.05% to 2% TiO₂.

13. The method according to claim 1, wherein the fraction contains from 0.1% to 3% K₂O.

14. The method according to claim 1, wherein the fraction contains 0.05% to 2% Na₂O.

15. The method according to claim 1, wherein the fraction contains from 0.01% to 1% P₂O₅.

16. The method according to claim 1, wherein the fraction contains from 0.005% to 0.2% Mn₂O₃.

17. The method according to claim 1, wherein the fraction contains from 0.05% to 3% SO₃.
